(19) United States
(12) Patent Application Publication
(10) Pub. No.: US 2025/0292473 A1
(43) Pub. Date: Sep. 18, 2025

(54) VEHICLE DISPLAY CONTROL DEVICE

(71) Applicant: TOYOTA JIDOSHA KABUSHIKI KAISHA, Toyota-shi (JP)

(72) Inventor: Miki Tsujino, Nagakute-shi (JP)

(73) Assignee: TOYOTA JIDOSHA KABUSHIKI KAISHA, Toyota-shi (JP)

(21) Appl. No.: 18/973,605

(22) Filed: Dec. 9, 2024

(30) Foreign Application Priority Data
Mar. 13, 2024 (JP) 2024-039315

(51) Int. Cl. G06T 13/00; G06V 20/58

(52) U.S. Cl. CPC G06T 13/00; G06V 20/58; G06V 2201/08

(57) ABSTRACT

The vehicle display control device includes a detection unit that detects a preceding vehicle preceding a traveling lane of the host vehicle and another vehicle traveling in an adjacent lane adjacent to the traveling lane, and a display control unit that, when the detection unit detects the preceding vehicle, causes only the other vehicle in a vehicle section that is a section between the host vehicle and the preceding vehicle among the other vehicles to be displayed as an image of another vehicle simulating the other vehicle.

### CROSS-REFERENCE TO RELATED APPLICATION

This application claims priority to Japanese Patent Application No. 2024-039315 filed on Mar. 13, 2024, incorporated herein by reference in its entirety.

### BACKGROUND

### 1. Technical Field

The disclosed technology relates to a vehicle display control device.

### 2. Description of Related Art

Japanese Patent No. 7086798 (JP 7086798 B) discloses that, while following a preceding vehicle, an indication of a surrounding situation is displayed, including images showing the preceding vehicle, a vehicle in an adjacent lane, and a host vehicle.

### SUMMARY

In the related art, it is necessary to select targets to be displayed when other objects cannot be sufficiently displayed to indicate the surrounding situation due to the space of a display unit, performance, or other issues. If the targets to be displayed are not selected appropriately, the user may feel uncomfortable.

An object of the present disclosure is to provide a vehicle display control device capable of selecting a vehicle to be displayed as surrounding information of a host vehicle without causing an uncomfortable feeling of a user.

A vehicle display control device according to an aspect includes: a detection unit configured to detect preceding vehicles preceding a traveling lane in which a host vehicle travels, and other vehicles traveling in adjacent lanes adjacent to the traveling lane; and
a display control unit configured to, when the detection unit detects the preceding vehicles, display only the other vehicle in an intervehicular section between the host vehicle and the preceding vehicles among the other vehicles as an other-vehicle image imitating the other vehicle. With the vehicle display control device according to the above aspect, it is possible to select the vehicle to be displayed as the surrounding information of the host vehicle without causing the uncomfortable feeling of the user.

In the vehicle display control device according to the above aspect, the display control unit may be configured to, when the detection unit detects the other vehicles without detecting the preceding vehicles, display the other vehicle traveling ahead in a traveling direction of the host vehicle among the other vehicles as the other-vehicle image. With the vehicle display control device according to the above aspect, the occupant can visually grasp the other vehicle that may be newly detected as the preceding vehicle when the lane is changed to the traveling lane.

In the vehicle display control device according to the above aspect, the display control unit may be configured to:
display, among the preceding vehicles detected by the detection unit, the preceding vehicle located closest to the host vehicle in the traveling lane as a preceding-vehicle image imitating the preceding vehicle; and
display, among the other vehicles detected by the detection unit, only the other vehicle located closest to the host vehicle in each of the adjacent lanes located on right and left sides of the traveling lane as the other-vehicle image. With the vehicle display control device according to the above aspect, the occupant can visually grasp the preceding vehicle having the shortest intervehicular distance or the other vehicle expected to have the shortest intervehicular distance when the lane is changed to the traveling lane among the other vehicles traveling in the adjacent lanes.

In the vehicle display control device according to the above aspect,
the display control unit may be configured to, when the other vehicle moves to the traveling lane between the host vehicle and the preceding vehicles, display the other vehicle as a preceding-vehicle image imitating the preceding vehicle. With the vehicle display control device according to the above aspect, the occupant can visually grasp that the other vehicle moving to the traveling lane is detected by the host vehicle as a new preceding vehicle.

In the vehicle display control device according to the above aspect,
the display control unit may be configured to display the other-vehicle image by animation when the other vehicle enters the intervehicular section, and hide the other-vehicle image by animation when the other vehicle exits the intervehicular section. With the vehicle display control device according to the above aspect, the occupant is less likely to feel visual discomfort about a change in displaying or hiding of the other-vehicle image.

According to the present disclosure, it is possible to select the vehicle to be displayed as the surrounding information of the host vehicle without causing the uncomfortable feeling of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle display control device according to an embodiment;

FIG. 2 is a block diagram illustrating a functional configuration of the vehicle display control device according to the embodiment;

FIG. 3 is a diagram illustrating an example of a display screen of a second display unit in a case where another vehicle is detected without detecting a preceding vehicle during automatic driving;

FIG. 4A is a diagram illustrating an example of a display screen of a second display unit when a preceding vehicle and another vehicle are detected during automated driving;

FIG. 4B is a diagram illustrating an example of a display screen of a second display unit when a preceding vehicle and another vehicle are detected during automated driving;

FIG. 5 is a diagram illustrating an exemplary display screen of a second display unit when another vehicle changes a lane to a traveling lane between the own vehicle and a preceding vehicle during automated driving; and

FIG. 6 is a flowchart illustrating an example of a flow of a display process according to the embodiment.

### DETAILED DESCRIPTION OF EMBODIMENTS

A vehicle display control device 10 mounted on a vehicle 12 (hereinafter, also referred to as a host vehicle) according to an embodiment will be described with reference to the drawings. The vehicle 12 is an example of a “host vehicle”.

### Hardware Configuration of the Vehicle Display Control Device 10

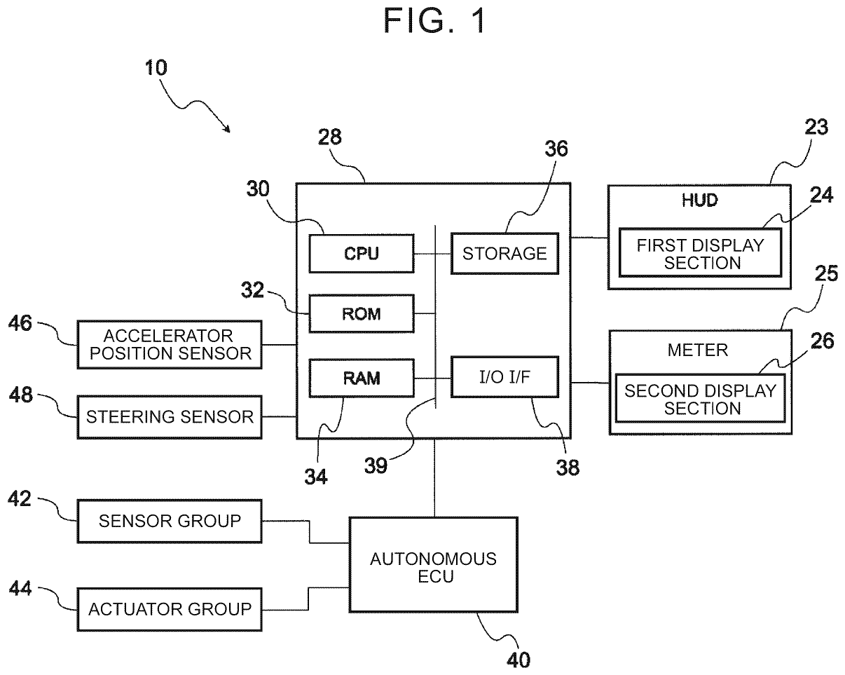

As illustrated in FIG. 1, the vehicle display control device 10 of the present embodiment includes an ECU (Electronic Control Unit) 28.

ECU 28 includes CPU (Central Processing Unit: processor) 30, ROM (Read Only Memory) 32, RAM (Random Access Memory) 34, storage 36, and input/output interface 38. The components are communicably connected to each other via an internal bus 39.

CPU 30 is a central processing unit that executes various programs and controls each unit. That is, CPU 30 reads the program from ROM 32 or the storage 36, and executes the program using RAM 34 as a working area. In addition, CPU 30 performs control of the above-described configurations and various arithmetic processes in accordance with programs recorded in ROM 32 or the storage 36.

The ROM 32 stores various programs and various data. RAM 34 temporarily stores a program/data as a working area. The storage 36 is a non-transitory recording medium configured by HDD (Hard Disk Drive) or SSD (Solid State Drive) and storing various programs including an operating system and various types of data. In the present embodiment, ROM 32 or the storage 36 stores a display program or the like for performing a display process. Various input/output devices are connected to the input/output interface 38.

Here, ECU 28 is electrically connected to the autonomous driving ECU 40. Like ECU 28, the autonomous driving ECU 40 includes a CPU, ROM, RAM (not shown), a storage, an input/output interface, and the like.

The autonomous driving ECU 40 is connected with a sensor group 42 for detecting the present condition of the vehicle and an actuator group 44 for controlling the travel of the vehicle. The sensor group 42 includes a plurality of sensors among various sensors such as cameras, radars, lidars (LIDAR: Light Detection and Ranging or Laser Imaging Detection and Ranging), and GPS (global positioning system) sensors. The camera captures an image of the surroundings of the vehicle. The radar detects a distance and a direction from an object in the vicinity of the vehicle by radio waves. The lidar detects a distance and a direction from an object in the vicinity of the vehicle by the laser beam. GPS sensor detects a present position of the vehicle. In addition, the sensor group 42 includes a sensor for detecting the state of the occupant. For example, the sensor group 42 may include a biological sensor that detects a heart rate, an arousal level, and the like of the occupant.

The actuator group 44 includes an acceleration/deceleration actuator for adjusting acceleration/deceleration of the vehicle and a steering actuator for driving a steering device of the vehicle. In the autonomous driving ECU 40, the autonomous driving of the vehicle is performed by controlling the operation of the actuator group 44 according to the present condition of the vehicle detected by the sensor group 42. The storage unit of the autonomous driving ECU 40 stores a scheduled route representing a route on which the 10 vehicle is scheduled to travel, and the autonomous driving ECU 40 causes the vehicle to travel along the scheduled route stored in the storage unit.

A head-up display device 23 and a meter 25 are connected to ECU 28. The first display unit 24 includes a projection surface projected by the head-up display device 23. The second display unit 26 is a display unit displayed on the meter 25, and the meter 25 is located in front of the driver's seat in an instrument panel (not shown) provided in the front portion of the vehicle cabin of the vehicle 12. The first display unit 24 and the second display unit 26 are provided at positions visible to the driver. As described above, the vehicle display control device 10, the first display unit 24, and the second display unit 26 constitute a vehicle display system.

An accelerator position sensor 46 and a steering sensor 48 are connected to ECU 28. The accelerator position sensor 46 is a sensor for detecting a position of an accelerator pedal (not shown) provided at a lower portion of the driver's seat. The steering sensor 48 is a sensor that detects a load applied to the steering wheel 16 by an occupant. That is, the steering sensor 48 of the present embodiment is configured not to detect a load when the steering wheel 16 is operated by the autonomous driving ECU 40 during autonomous driving. In addition, the steering sensor 48 of the present embodiment is configured to detect a load when the occupant operates the steering wheel 16.

### Functional Configuration of Vehicle Display Control Device 10

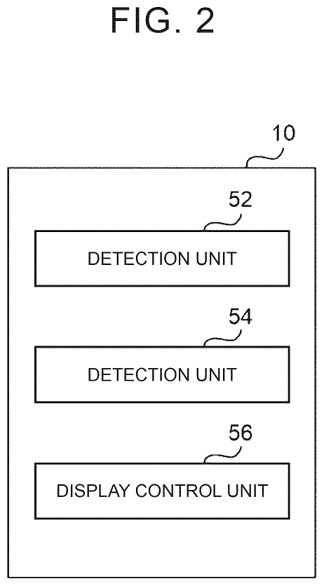

The vehicle display control device 10 realizes various functions using the above-described hardware resources. A functional configuration realized by the vehicle display control device 10 will be described with reference to FIG. 2.

As illustrated in FIG. 2, the vehicle display control device 10 includes a detection unit 52, a detection unit 54, and a display control unit 56 as a functional configuration. The respective functional configurations are realized by CPU 30 of ECU 28 reading and executing the programs.

The detection unit 52 detects a vehicle around the vehicle 12. Specifically, the detection unit 52 detects a vehicle that travels ahead of a lane (hereinafter, a traveling lane) on which the vehicle 12 travels (hereinafter, a preceding vehicle) and a vehicle that travels on a lane (hereinafter, an adjacent lane) adjacent to the traveling lane (hereinafter, another vehicle). For example, the detection unit 52 acquires information about surrounding vehicles based on a signal from the autonomous driving ECU 40.

The detection unit 54 detects a section between the vehicle 12 and the preceding vehicle. Specifically, the detection unit 54 detects a section including a section (hereinafter, also referred to as an adjacent section) corresponding to a section between the vehicle 12 and the preceding vehicle in the adjacent lane. For example, the detection unit 54 acquires information about a section between the vehicle 12 and the preceding vehicle based on a signal from the autonomous driving ECU 40. The section between the vehicle 12 and the preceding vehicle is an example of a “vehicle section”.

The display control unit 56 displays the peripheral information of the vehicle 12 in a display area (hereinafter, also referred to as a display area) of the second display unit 26 provided in the vehicle cabin. Specifically, the display control unit 56 acquires a signal from the sensor group 42, and displays peripheral information of the vehicle 12 based on the acquired signal in the display area.

In addition, when the detection unit 52 detects a preceding vehicle or another vehicle, the display control unit 56 changes the display screen of the second display unit 26. The display control unit 56 changes the display screen displayed on the second display unit 26 when the detection unit 54 detects that another vehicle enters the adjacent section or the other vehicle leaves the adjacent section. Specifically, the display control unit 56 changes the display of the other-vehicle image M3 described later by animating. The animation of the present embodiment includes, but is not limited to, images such as fade-in and fade-out, which are displayed or hidden. For example, images of different images may be continuously changed, colors may be changed with image movement, or brightness may be changed. Note that the display control unit 56 may change the display of the preceding vehicle image M2, which will be described later, by animating. In addition, the fade-in of the present embodiment means that the image is gradually displayed from the front side, and the fade-out means that the image is gradually hidden from the back side. Here, the “front side” is a direction approaching the vehicle image M1 and coincides with the downward direction in the second display unit 26. The “rear side” is a direction away from the vehicle image M1 and coincides with the upward direction in the second display unit 26. That is, when the image is displayed, the image is displayed from the side closer to the vehicle image M1, and when the image is hidden, the image is hidden from the side farther from the vehicle image M1, so that it is difficult for the occupant to feel visual discomfort with respect to the display and non-display of the image.

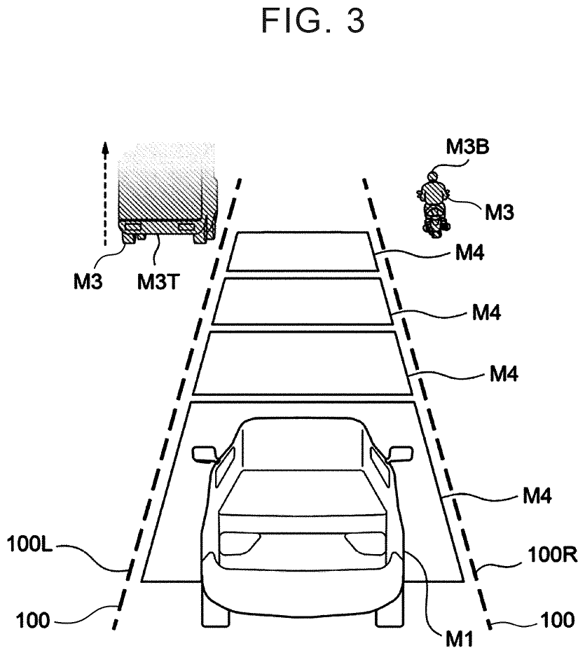

Hereinafter, a part of the display screen of the second display unit 26 displayed by the function of the display control unit 56 during the automatic operation will be described with reference to FIG. 3 to FIG. 5.

FIG. 3 is an example of a display screen of the second display unit 26 in a case where another vehicle is detected without detecting the preceding vehicle. As illustrated in FIG. 3, in the display area, a vehicle image M1 simulating the vehicle 12, other-vehicle images M3 simulating other vehicles traveling in the neighboring lanes, and an inter-vehicle target M4 indicating the setting of the inter-vehicle distance during autonomous driving are displayed. The other-vehicle images M3 of the present embodiment includes other-vehicle image M3T indicating a large vehicle such as a truck, and other-vehicle image M3B indicating a two-wheeled vehicle such as a motorcycle. The other-vehicle image M3 may include an image indicating a passenger car.

Here, the vehicle image M1 is displayed in a region (hereinafter, referred to as a traveling lane region) that is a lower portion of the display region and is sandwiched between lane auxiliary lines 100 indicating the traveling lane and is superimposed on the inter-vehicle target M4. Here, the lane auxiliary lines 100 includes a lane auxiliary line 100L indicating the left end of the traveling lane region and a lane auxiliary line 100R indicating the right end of the traveling lane region. The directions indicated by “left” and “right” are the left direction and the right direction toward the traveling direction of the vehicle 12, and coincide with the left direction and the right direction of the second display unit 26. As an example, in FIG. 3, the vehicle image M1 is displayed as an image simulating a white passenger car.

The other-vehicle image M3 is a display area, and is displayed outside the traveling lane area. Specifically, the other-vehicle image M3 is displayed in a color (for example, gray) that differs from the vehicle image M1 in a left region (hereinafter, referred to as a left lane region) of the lane auxiliary line 100L indicating the left adjacent lane and in a right region (hereinafter, referred to as a right lane region) of the lane auxiliary line 100R indicating the right adjacent lane. In addition, the other-vehicle images M3 are displayed with the displayed position and size changed in accordance with the relative positional relation between the vehicle 12 and the other vehicle. For example, as the other vehicle moves away from the front side of the vehicle 12, the other-vehicle image M3 are displayed in a reduced size at an upper portion of the display area. Here, “front” is a traveling direction of the vehicle 12 and coincides with an upward direction of the second display unit 26. When the other-vehicle image M3 appears in the display area, it is displayed in a fade-in manner, and when the other-vehicle image M3 disappears from the display area, it is faded-out and is not displayed.

As an example, in FIG. 3, the other-vehicle image M3T is gray and is displayed in front of the left-lane area. Here, a dashed arrow in FIG. 3 indicates a state in which an image is displayed by fade-in. Specifically, the other-vehicle image M3T is gradually displayed from the front side along the direction indicated by the broken line arrow in FIG. 3. The other-vehicle image M3B is gray and is displayed in front of the right-lane area. As described above, the other-vehicle image M3T is faded in and displayed, thereby indicating that a large vehicle such as a truck is detected in the left neighboring lane. In addition, the other-vehicle image M3B is displayed to indicate that a two-wheeled vehicle such as a motorcycle is present in the neighboring right-hand lane.

In the inter-vehicle target M4, the number corresponding to the specified value of the inter-vehicle distance setting between the vehicle 12 and the preceding vehicle to be followed is displayed in the traveling lane area. In the present embodiment, four inter-vehicle targets M4 are displayed when the designated value is “longest”, three inter-vehicle targets M4 are displayed when the designated value is “long”, two inter-vehicle targets M4 are displayed when the designated value is “middle”, and one inter-vehicle target M4 is displayed when the designated value is “short”. As an example, in FIG. 3, the designated value is “the longest”, and thus four inter-vehicle targets M4 are displayed.

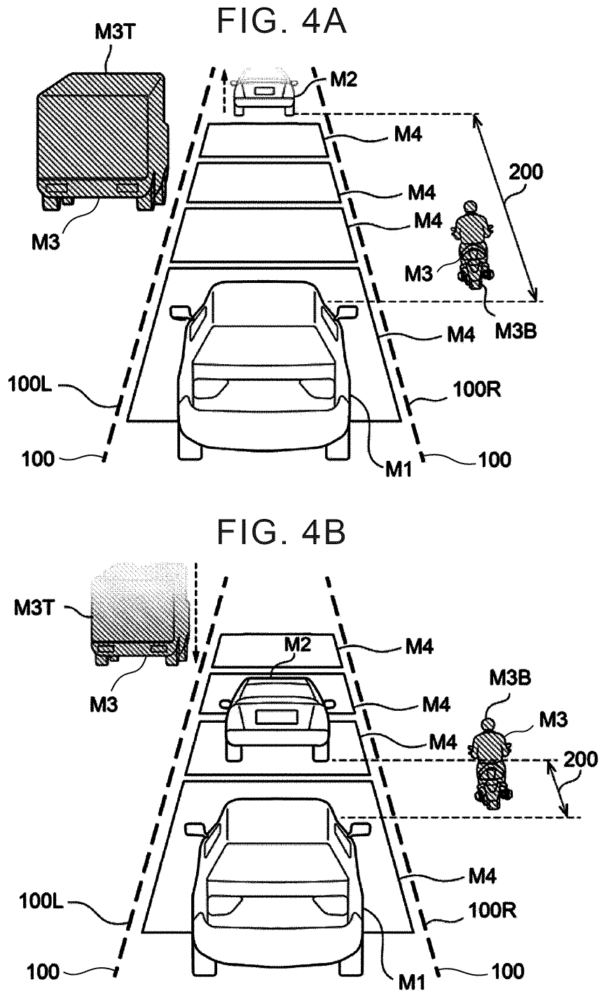

FIGS. 4A and 4B are exemplary displays of the second display unit 26 when the preceding vehicle and the other vehicle are detected. As shown in FIGS. 4A and 4B, in the display area, the vehicle image M1, the preceding vehicle image M2 simulating the preceding vehicle preceding the traveling lane, the other-vehicle images M3, and the inter-vehicle target M4 are displayed. Here, when the detection unit 52 detects a plurality of other vehicles in each of the adjacent sections, only the other-vehicle images M3 indicating the other vehicles positioned closest to the vehicle 12 in each of the adjacent sections are displayed in the display area. Note that the preceding vehicle image M2 may include an image indicating a passenger vehicle, an image indicating a large vehicle such as a truck, an image indicating a two-wheeled vehicle such as a motorcycle, and the like. The position closest to the vehicle 12 is an example of “the position closest to the host vehicle side from the host vehicle”.

The preceding vehicle image M2 is displayed on the traveling lane area so as to be superimposed on the inter-vehicle target M4. In addition, the preceding vehicle image M2 is displayed by changing the display position and the size according to the relative positional relation between the vehicle 12 and the preceding vehicle. For example, as the relative-positional relation between the vehicle 12 and the preceding vehicle is separated, the preceding vehicle image M2 is reduced and displayed in the upper part of the display area. When the preceding vehicle image M2 appears in the display area, it is displayed in a fade-in manner, and when the preceding vehicle image M2 disappears from the display area, it is faded-out and is not displayed. As an example, in FIG. 4A, the preceding vehicle image M2 is an image simulating a white passenger vehicle that differs from the vehicle image M1, and is displayed in front of the traveling lane area. Here, a dashed arrow in FIG. 4A of the drawing indicates how images are displayed by fade-in. Specifically, the preceding vehicle image M2 is gradually displayed from the front side along the direction indicated by the broken-line arrow in FIG. 4A. As described above, the preceding vehicle image M2 is displayed in white to indicate that the preceding vehicle indicated by the preceding vehicle image M2 is a tracking target in the automated driving. In addition, the preceding vehicle image M2 is faded in and displayed to indicate that the preceding vehicle has been detected in the traveling lane.

As shown in FIG. 4A, an other-vehicle image M3T is displayed for one vehicle in a section indicated by an inter-vehicle section 200 in the left lane region, and an other-vehicle image M3B is displayed for one vehicle in a section indicated by an inter-vehicle section 200 in the right lane region. Here, the inter-vehicle section 200 is a width indicating a section detected by the detection unit 54, and indicates a width of a section between the vehicle image M1 and the preceding vehicle image M2 in the display area. In addition, as shown in FIG. 4B, when the vehicle image M1 and the preceding vehicle image M2 approach each other because the distance between the vehicle 12 and the preceding vehicle is narrowed, the section indicated by the inter-vehicle section 200 is also shortened. Therefore, the other-vehicle image M3T deviating from the section indicated by the inter-vehicle section 200 is not displayed. Here, a dashed arrow in FIG. 4B indicates a state in which images are hidden due to fade-out. Specifically, the other-vehicle image M3T is gradually hidden from the back side along the direction indicated by the dashed arrow in FIG. 4B. As described above, by displaying only the other-vehicle image M3 in the section indicated by the inter-vehicle section 200, only the other vehicle that is likely to become the preceding vehicle as the tracking target in the autonomous driving when the lane change to the traveling lane is performed is displayed as the other-vehicle image M3.

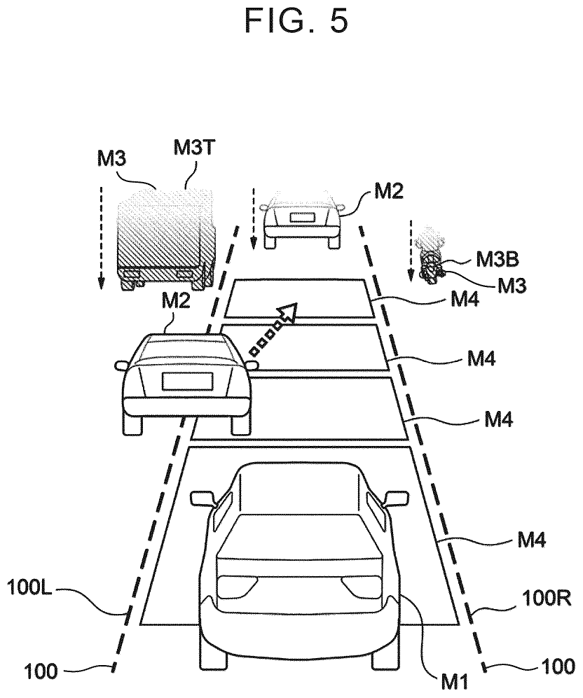

FIG. 5 is an example of the display screen of the second display unit 26 when the other vehicle changes the lane to the traveling lane between the vehicle 12 and the preceding vehicle.

As shown in FIG. 5, the other vehicle that changes the lane from the left neighboring lane to the traveling lane is displayed as the preceding vehicle image M2. Here, the broken-line arrow in FIG. 5 indicates a state where the image is moving. Specifically, the preceding vehicle image M2 is displayed by gradually moving in the direction indicated by the outlined broken-line arrow in FIG. 5. In addition, the preceding vehicle image M2 that has been displayed in front of the traveling lane area so far is not displayed. The other-vehicle images M3T, M3B that are outside the section indicated between the vehicle image M1 and the new preceding vehicle image M2 is also not displayed. Here, a dashed arrow in FIG. 5 indicates a state in which an image is hidden due to fade-out. Specifically, the preceding vehicle image M2 and the other-vehicle images M3T, M3B are gradually hidden from the back side along the direction indicated by the broken line arrow in FIG. 5. In this way, the other vehicle that has interrupted between the vehicle 12 and the preceding vehicle and has undergone the lane change is displayed as a new preceding vehicle image M2. On the other hand, by hiding the preceding vehicle image M2 that has been displayed so far, only the preceding vehicle image M2 indicating the preceding vehicle to be followed during the automated driving is displayed. In addition, when the other-vehicle images M3T, M3B are not displayed, it is displayed that there is no other vehicle that may be a preceding vehicle as a follow-up target at the time of autonomous driving due to a lane change to the traveling lane.

### Actions

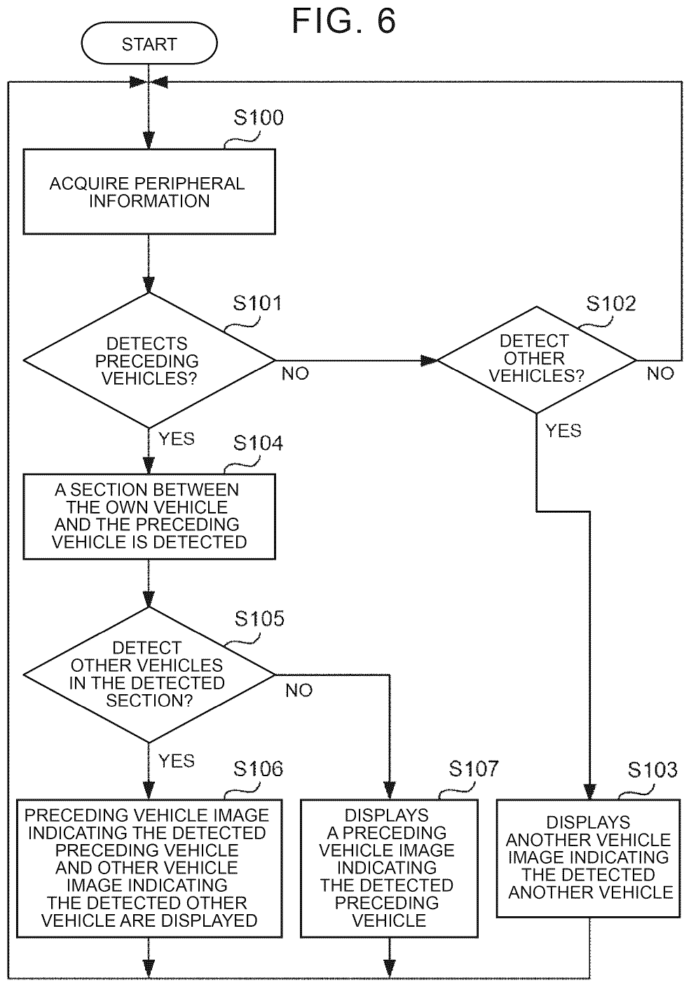

FIG. 6 is a flowchart illustrating an example of a flow of a display process performed by the vehicle display control device 10. This displaying process is executed by CPU 30 of ECU 28 reading the program from ROM 32 or the storage 36, expanding the program in RAM 34, and executing the program. As an example, the display process illustrated in FIG. 6 is repeatedly executed while the vehicle 12 is traveling with respect to the display of the vehicle image M1 and the inter-vehicle target M4 in the display area. Further, in the following process, when the preceding vehicle image M2 and the other-vehicle image M3 are newly displayed or hidden, they are displayed or hidden by animation (fade-in, fade-out, etc.).

In S100 of FIG. 6, CPU 30 acquires the neighborhood data. Specifically, CPU 30 acquires a signal from the sensor group 42 by the function of the display control unit 56, and acquires surrounding information of the vehicle 12 based on the acquired signal.

In S101, CPU 30 determines whether the preceding vehicles have been detected. If CPU 30 determines that a preceding vehicle preceding the traveling lane has been detected (S101: YES), it proceeds to S104. On the other hand, when it is determined that the preceding vehicle preceding the traveling lane has not been detected (S101: NO), CPU 30 proceeds to S102. CPU 30 may detect, as the preceding vehicle, another vehicle that changes the lane from the neighboring lane to the traveling lane.

In S102, CPU 30 determines whether other vehicles have been detected. If it is determined that another vehicle located in front of the vehicle 12 has been detected (S102: YES), CPU 30 proceeds to S103. On the other hand, when it is determined that another vehicle located in front of the vehicle 12 has not been detected (S102: NO), CPU 30 returns to S100.

In S103, CPU 30 displays other-vehicle image M3 indicating the detected other vehicle. Specifically, CPU 30 displays the other-vehicle image M3 indicating the other vehicles detected by S102 in the display area (see FIG. 3). CPU 30 then returns to S100.

In S104, CPU 30 detects a section between the host vehicle and the preceding vehicle. Specifically, CPU 30 detects a section including a neighboring section.

In S105, CPU 30 determines whether another vehicle is detected in the detected section. CPU 30 proceeds to S106 when it is determined that another vehicle is detected in the detected section (S105: YES). On the other hand, when CPU 30 determines that no other vehicles are detected in the detected section (S105: NO), the process proceeds to S107.

In S106, CPU 30 displays the preceding vehicle image M2 indicating the detected preceding vehicle and the other-vehicle image M3 indicating the detected other vehicle. Specifically, CPU 30 causes the display area to display the preceding vehicle image M2 indicating the preceding vehicle detected by S101 and the other-vehicle image M3 indicating the other vehicle detected by S105 (refer to FIG. 4A). CPU 30 then returns to S100. When CPU 30 detects another vehicle that is out of the detected section, it hides the other-vehicle image M3 indicating the other vehicle (see FIG. 4B).

In S107, CPU 30 displays a preceding vehicle image M2 indicating the detected preceding vehicle. Specifically, CPU 30 causes the display area to display the preceding vehicle image M2 indicating the preceding vehicle detected by S101. CPU 30 then returns to S100. When CPU 30 detects, in S101, another vehicle that performs lane change from the adjacent lane as the preceding vehicle, the other-vehicle image M3 indicating the other vehicle is displayed as the preceding vehicle image M2. In addition, CPU 30 hides the preceding vehicle image M2 indicating the preceding vehicle deviating from the detected section and the other-vehicle image M3 indicating the other vehicle deviating from the detected section (see FIG. 5).

As described above, in the vehicle display control device 10 according to the present embodiment, when the preceding vehicle and the other vehicle are detected, only the other vehicle traveling in the adjoining section is displayed as the other-vehicle image M3. Therefore, according to the vehicle display control device 10 of the present embodiment, it is possible to select the vehicle to be displayed as the surrounding information of the vehicle 12 without giving a sense of discomfort to the occupant. In addition, even when the target object indicating the surrounding condition cannot be sufficiently displayed due to the space of the second display unit 26, the other vehicle that may be recognized as the preceding vehicle by the lane change is displayed as the other-vehicle image M3. Therefore, it is difficult for the occupant to feel uncomfortable with the change in the display when the other vehicle changes the lane to the traveling lane.

In the vehicle display control device 10 according to the present embodiment, when the other vehicle is detected without detecting the preceding vehicle, the other vehicle located in front of the traveling direction of the vehicle 12 is displayed in the display area as the other-vehicle image M3. Therefore, according to the vehicle display control device 10 of the present embodiment, the occupant can visually understand another vehicle that may be newly detected as a preceding vehicle when a lane change is made to the traveling lane.

In the vehicle display control device 10 according to the present embodiment, the preceding vehicle on the traveling lane located farthest from the vehicle 12 is displayed as the preceding vehicle image M2 in the display area. In addition, the vehicle display control device 10 causes other vehicles on the neighboring lanes located farthest from the vehicle 12 to be displayed as other-vehicle images M3. Therefore, according to the vehicle display control device 10 of the present embodiment, the occupant can visually understand the preceding vehicle having the shortest inter-vehicle distance or the other vehicle having the shortest inter-vehicle distance when the lane is changed to the traveling lane among the other vehicles traveling in the adjacent lanes.

In the vehicle display control device 10 according to the present embodiment, when the other vehicle changes the lane to the traveling lane between the vehicle 12 and the preceding vehicle, the other vehicle is displayed as the preceding vehicle image M2. Therefore, according to the vehicle display control device 10 of the present embodiment, the occupant can visually understand that the other vehicle that is changing the lane from the adjacent lane to the traveling lane is detected by the vehicle 12 as a new preceding vehicle.

In the vehicle display control device 10 according to the present embodiment, when the other vehicle enters the neighboring section, the other-vehicle image M3 indicating the other vehicle is faded in and displayed. Further, in the vehicle display control device 10, when the other vehicle leaves the adjoining section, the other-vehicle image M3 indicating the other vehicle is faded out to be hidden. Therefore, according to the vehicle display control device 10 of the present embodiment, it is difficult for the occupant to feel a visual discomfort with respect to a change in the display or non-display of the other-vehicle image M3.

### Other Embodiments

In the above-described embodiment, the vehicle display control device 10 displays the peripheral information of the vehicle 12 on the second display unit 26, but the present disclosure is not limited thereto. The vehicle display control device 10 may display the surrounding information of the vehicle 12 on the first display unit 24. At this time, an image similar to that of the second display unit 26 is displayed on the first display unit 24, but when the display area of the first display unit 24 is narrower than the display area of the second display unit 26, a part of the image of the second display unit 26 may be displayed on the first display unit 24.

In the above-described embodiment, the vehicle display control device 10 displays one preceding vehicle image M2 or other-vehicle images M3 on each of the traveling lane and the neighboring lanes, but is not limited thereto. The vehicle display control device 10 may display a plurality of preceding vehicle images M2 on the traveling lane and display a plurality of other-vehicle images M3 on the neighboring lanes.

In the above-described embodiment, the vehicle display control device 10 does not display the other-vehicle image M3 indicating the other vehicle that is out of the neighboring section among the other vehicles, but is not limited to this. The vehicle display control device 10 may not display the other-vehicle image M3 for a section in which the road marking indicating the border line with the neighboring lane is a road marking (for example, a solid yellow line) indicating that the vehicle change is prohibited.

In the above-described embodiment, when the other vehicle changes the lane to the traveling lane, the vehicle display control device 10 fades out the preceding vehicle image M2 that has been displayed in the traveling lane so far and hides the preceding vehicle images. The vehicle display control device 10 may change the color of the preceding vehicle image M2 displayed in the traveling lane to a different color (for example, gray color) to display it.

Note that the control process executed by CPU 30 reading the software (program) in the above-described embodiment may be executed by various processors other than CPU. Examples of the processor include a PLD (Programmable Logic Device) that allows changing a circuit configuration after manufacturing of FPGA (Field-Programmable Gate Array), and the like, and a dedicated electric circuit that is a processor having a circuit configuration designed exclusively for executing a particular process such as ASIC (Application Specific Integrated Circuit), and the like. In addition, the control process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above-described embodiment, the program is stored (installed) in ROM 32 or the storage 36 in advance, but the present disclosure is not limited thereto. The program may be provided in a form recorded in a recording medium such as CD-ROM (Compact Disk Read Only Memory), DVD-ROM (Digital Versatile Disk Read Only Memory), and USB (Universal Serial Bus). The program may be downloaded from an external device via a network.

What is claimed is:

1. A vehicle display control device comprising:
a detection unit configured to detect preceding vehicles preceding a traveling lane in which a host vehicle travels, and other vehicles traveling in adjacent lanes adjacent to the traveling lane; and
a display control unit configured to, when the detection unit detects the preceding vehicles, display only the other vehicle in an intervehicular section between the host vehicle and the preceding vehicles among the other vehicles as an other-vehicle image imitating the other vehicle.

2. The vehicle display control device according to claim 1, wherein the display control unit is configured to, when the detection unit detects the other vehicles without detecting the preceding vehicles, display the other vehicle traveling ahead in a traveling direction of the host vehicle among the other vehicles as the other-vehicle image.

3. The vehicle display control device according to claim 1, wherein the display control unit is configured to:
display, among the preceding vehicles detected by the detection unit, the preceding vehicle located closest to the host vehicle in the traveling lane as a preceding-vehicle image imitating the preceding vehicle; and
display, among the other vehicles detected by the detection unit, only the other vehicle located closest to the host vehicle in each of the adjacent lanes located on right and left sides of the traveling lane as the other-vehicle image.

4. The vehicle display control device according to claim 1, wherein the display control unit is configured to, when the other vehicle moves to the traveling lane between the host vehicle and the preceding vehicles, display the other vehicle as a preceding-vehicle image imitating the preceding vehicle.

5. The vehicle display control device according to claim 1, wherein the display control unit is configured to display the other-vehicle image by animation when the other vehicle enters the intervehicular section, and hide the other-vehicle image by animation when the other vehicle exits the intervehicular section.
